(19) United States
(12) Patent Application Publication
(10) Pub. No.: US 2025/0340463 A1
(43) Pub. Date: Nov. 6, 2025

(54) WATER TREATMENT SYSTEM AND METHOD FOR OPERATING WATER TREATMENT SYSTEM

(71) Applicant: ORGANO CORPORATION, Tokyo (JP)

(72) Inventors: Yuki NAKAMURA, Tokyo (JP); Kazushige TAKAHASHI, Tokyo (JP); Koichiro HASHIMOTO, Tokyo (JP); Hyeongseok PARK, Tokyo (JP); Fumisato KATO, Tokyo (JP); Shinichi SHINODA, Tokyo (JP); Hitoshi TANAKA, Tokyo (JP); Nobuhisa YOSHIDA, Tokyo (JP)

(73) Assignee: ORGANO CORPORATION, Tokyo (JP)

(21) Appl. No.: 18/879,080

(22) PCT Filed: Mar. 13, 2023
(86) PCT No.: PCT/JP2023/009630

§ 371 Date: Dec. 26, 2024

(30) Foreign Application Priority Data
Jul. 28, 2022 (JP) 2022-120285

(51) Int. Cl. C02F 1/42; C02F 1/44

(52) U.S. Cl. CPC C02F 1/42; C02F 1/44; C02F 2001/422; C02F 2001/425; C02F 2201/005; C02F 2209/03; C02F 2209/05; C02F 2209/06; C02F 2209/20; C02F 2303/16

(57) ABSTRACT

A water treatment system that is equipped with a membrane separator and an ion exchange device and that treats target water includes a first distribution pipe that simultaneously supplies chemical solution to the membrane separator and the ion exchange device in parallel, a first group of valves installed in the first distribution pipe, and a controller that controls the opening and closing of the first group of valves.

### TECHNICAL FIELD

This invention relates to a water treatment system and a method for operating the water treatment system.

### BACKGROUND OF ART

In a water treatment system, a degasser equipped with a degassing membrane is used to remove dissolved gases (CO₂ and O₂) from the water being treated. Water treatment devices such as ion exchange resins, reverse osmosis membranes, and ultrafiltration membranes are used to remove ions and total organic carbon (TOC) contained in the water being treated. Multiple units of these degassers and water treatment devices are combined to form a water treatment system.

Blockage, also referred to as fouling, occurs as a degassing membrane is being used due to the adhesion and deposition of organic and inorganic materials on the membrane surface. The occurrence of fouling causes the degassing performance and water passage performance of a degasser to deteriorate, and degassing membranes therefore need to be cleaned periodically to remove adhered and deposited organic and inorganic materials. Chemical solutions such as acids and alkalis are used to clean degassing membranes (see, for example, Patent Document 1).

Periodic cleaning and regeneration operations are also required for water treatment devices. For example, ion exchange resins require periodic regeneration with chemical solutions. Membranes such as reverse osmosis and ultrafiltration membranes are also cleaned with chemical solutions to restore membrane performance degraded by fouling. In addition, a technique is being considered in which a chemical solution used to clean a water treatment device is used to clean another water treatment device (see, for example, Patent Document 2).

### PRIOR ART DOCUMENTS

### Patent Documents

Patent Document 1: JP 2007-090249 A

Patent Document 2: JP 2016-022447 A

### SUMMARY OF THE INVENTION

### Problem to be Solved by the Invention

Cleaning and regeneration of devices as described above is done for each device such as a degasser and water treatment device. When cleaning or regenerating a degasser or water treatment device, operation of the degasser, water treatment device, or system equipped with these devices is often halted and the device to be cleaned or regenerated is disconnected from the main line. Therefore, frequent cleaning and regeneration can significantly reduce system availability. In addition, the technology described in Patent Document 2 requires more ancillary equipment and makes the system configuration more complex.

The purpose of the present invention is to provide a water treatment system and a method for operating the water treatment system that can easily reduce the system shutdown time associated with device regeneration.

Means for Solving the Problem

A water treatment system of the present invention is the water treatment system equipped with a membrane separator and an ion exchange device, comprising:
a first distribution pipe that supplies chemical solution to the membrane separator and the ion exchange device in parallel at the same time;
a first group of valves that is installed in the first distribution pipe; and
a controller that controls the opening and closing of the first group of valves.

A water treatment system of the present invention is the water treatment system equipped with a membrane separator and an ion exchange device, comprising:
a first distribution pipe that supplies chemical solution to the membrane separator;
a second distribution pipe that supplies the chemical solution that has passed through the membrane separator to the ion exchange device;
a first group of valves that is installed in the first distribution pipe;
a second group of valves that is installed in the second distribution pipe; and
a controller that controls the opening and closing of the first group of valves and the second group of valves, wherein
the controller controls the opening and closing of the second group of valves so that the chemical solution that has passed through the membrane separator is supplied to the ion exchange device.

A method for operating a water treatment system of the present invention is the method for operating a water treatment system equipped with a membrane separator and an ion exchange device, the method comprising:
a water flow process for causing treated water to flow through the membrane separator and the ion exchange device by controlling the opening and closing of valves located in a distribution pipe; and
a chemical flow process for supplying chemical solution to the membrane separator and the ion exchange device in parallel simultaneously by controlling the opening and closing of the valves based on a predetermined timing.

### Advantageous Effects of the Invention

In the present invention, the system shutdown time associated with device regeneration can be easily reduced.

### BRIEF DESCRIPTION OF THE DRAWINGS

FIG. 1 is a diagram showing an example of the configuration of a typical water treatment system.

FIG. 2 is a diagram showing a first embodiment of the water treatment system of the present invention.

FIG. 3 is a flowchart illustrating a first example of the operation method in the water treatment system shown in FIG. 2.

FIG. 4 is a flowchart illustrating a second example of the operation method in the water treatment system shown in FIG. 2.

FIG. 5 is a diagram showing a second embodiment of the water treatment system of the present invention.

FIG. 6 is a flowchart illustrating an example of the operation method in the water treatment system shown in FIG. 5.

FIG. 7 is a diagram showing a third embodiment of the water treatment system of the present invention.

FIG. 8 is a flowchart illustrating an example of the operation method in the water treatment system shown in FIG. 7.

FIG. 9 is a diagram showing a fourth embodiment of the water treatment system of the present invention.

FIG. 10 is a flowchart illustrating an example of the operation method in the water treatment system shown in FIG. 9.

FIG. 11 is a table showing the results of Examples 1 and 2 and a comparative example.

### DESCRIPTION OF THE EMBODIMENTS

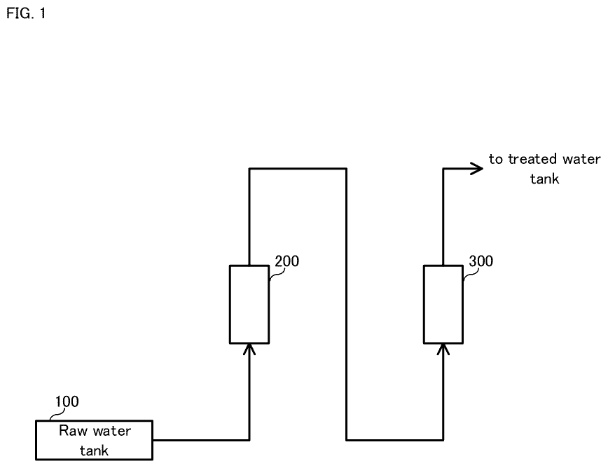

Embodiments of the invention are next described with reference to the drawings. FIG. 1 is a diagram showing an example of the configuration of a typical water treatment system. The water treatment system shown in FIG. 1 includes raw water tank 100, degasser 200, and water treatment device 300. Raw water tank 100 is a tank for storing raw water, which is the liquid to be treated. During the water flow process of conveying raw water, the liquid stored in raw water tank 100 is supplied from raw water tank 100 to degasser 200 using, for example, a pump. Degasser 200 removes dissolved gases contained in the liquid supplied from raw water tank 100. Degasser 200 is, for example, a membrane degasser that uses a polymer membrane to remove dissolved gases such as dissolved oxygen and free carbon dioxide by membrane permeation. Membrane degassers that remove free carbon dioxide are sometimes referred to as decarbonation membrane devices. The type of dissolved gas removed by the membrane degasser in the present invention is not limited. For example, the membrane degasser in the present invention may remove dissolved gases regardless of type, or it may remove a specific type of dissolved gas. The liquid from which dissolved gases have been removed in degasser 200 is supplied to water treatment device 300 in the water flow process. Water treatment device 300 is connected in series with degasser 200 and removes impurities from the liquid supplied by degasser 200. Water treatment device 300 can be, for example, an ion exchange device filled with ion exchange resin. Ion exchange resins that can be used include cation exchange resins that remove cationic components from water and anion exchange resins that remove anionic components from water. Water treatment device 300 can be a UF (ultrafiltration device) or an RO (reverse osmosis) membrane. The liquid treated in water treatment device 300 (treated water) is stored in a treated water tank or treated by other unit operations as necessary during the water flow process. Depending on the quality of the raw water or the purity of the water after treatment, the water is used as pure water or ultrapure water for the production of semiconductors and other electronic components, or for general-use water in factories. Other water treatment devices (e.g., cation exchange resin devices filled with cation exchange resin) may be arranged between raw water tank 100 and degasser 200.

The invention described below relates to the regeneration and cleaning of used components in a water treatment system that performs the water flow process as shown in FIG. 1.

### First Embodiment

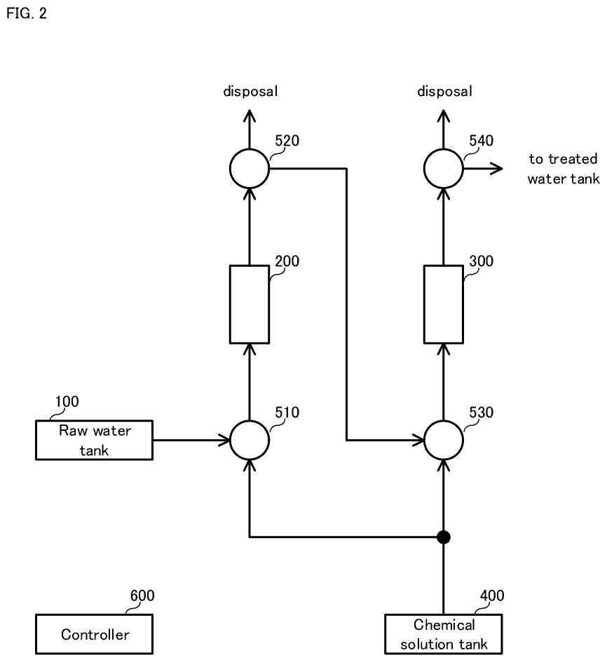

FIG. 2 is a diagram showing the first embodiment of the water treatment system of the present invention. As shown in FIG. 2, the water treatment system in this embodiment includes raw water tank 100, degasser 200 (membrane separator), and water treatment device 300 (ion exchange device). These components are the same as those shown in FIG. 1. Here, a membrane separator is a device that uses a separation membrane to remove, for example, ions, TOC, suspended solids (SS), and gas components from raw water. Separation membranes include microfiltration membranes, ultrafiltration membranes, nanofiltration membranes, reverse osmosis membranes, and degassing membranes (decarbonation membranes). Furthermore, as shown in FIG. 2, the water treatment system in this embodiment includes chemical solution tank 400, a plurality of valves 510, 520, 530, and 540, which are on-off valves, and controller 600. The first group of valves consists of valve 510 and valve 530. These components are connected to each other via a distribution pipe. In this embodiment, the distribution pipe from chemical solution tank 400 to degasser 200 and water treatment device 300 is the first distribution pipe. The distribution pipe from degasser 200 to water treatment device 300 via valves 520 and 530 is the second distribution pipe.

Chemical solution tank 400 stores a chemical solution for regenerating degasser 200 and water treatment device 300. When water treatment device 300 is filled with an anion exchange resin, the chemical solution stored in chemical solution tank 400 is, for example, an alkaline chemical solution such as a sodium hydroxide solution or potassium hydroxide solution. When water treatment device 300 is filled with a cation exchange resin, the chemical solution stored in chemical solution tank 400 is an acidic chemical solution such as hydrochloric acid or sulfuric acid. In the chemical flow process, the chemical solution stored in chemical solution tank 400 is supplied from chemical solution tank 400 to valves 510 and 530 using, for example, a pump to convey the chemical solution. Instead of supplying the chemical solution stored in chemical solution tank 400 to valves 510 and 530, a method may be used in which clear water such as RO-treated water, ion-exchanged water, or pure water is mixed with a chemical solution such as sodium hydroxide in the line and then adjusted before being supplied to valves 510 and 530. The chemical solution from chemical solution tank 400 is supplied simultaneously and in parallel to degasser 200 and water treatment device 300 via the first distribution pipe. The meaning of “simultaneous” here does not necessarily mean that the timing is exactly the same, but also includes the meaning that, as long as the effect of the invention can be achieved, the timings differ by less than a predetermined time. This sense of “simultaneous” is the same in the embodiments described below.

Controller 600 controls the opening and closing of valves 510, 520, 530, and 540 located in the pathways by which, for example, liquids to be treated, liquids after treatment, and chemical solutions are distributed. During the chemical flow process, controller 600 controls the opening and closing of valves 510 and 530 so that the chemical solution supplied from chemical solution tank 400 is supplied in parallel to degasser 200 and water treatment device 300. Specifically, controller 600 controls the opening and closing of valve 510 so that liquid from raw water tank 100 is not supplied to degasser 200 and chemical solution from chemical solution tank 400 is supplied to degasser 200. Controller 600 also controls the opening and closing of valve 530 so that liquid from valve 520 is not supplied to water treatment device 300 and chemical solution from chemical solution tank 400 is supplied to water treatment device 300. In addition, controller 600 controls the opening and closing of valve 520 so that the liquid flowing out of degasser 200 flows into the path for disposal. Controller 600 also controls the opening and closing of valve 540 so that the liquid flowing out of water treatment device 300 flows into the path for disposal.

The timing of the transition from the water flow process to the chemical flow process may accord with a predetermined schedule. The timing of the transition from the water flow process to the chemical flow process can be based on the difference between the pressure at the front of degasser 200, i.e., the raw water side (raw water tank 100 side), and the pressure at the back of degasser 200, i.e., the treated water side (water treatment device 300 side). Specifically, if the difference between the pressure on the raw water side of degasser 200 and the pressure on the permeate side of degasser 200 exceeds a predetermined threshold, controller 600 controls the opening and closing of valves 510, 520, 530, and 540 to transition from the water flow process to the chemical flow process.

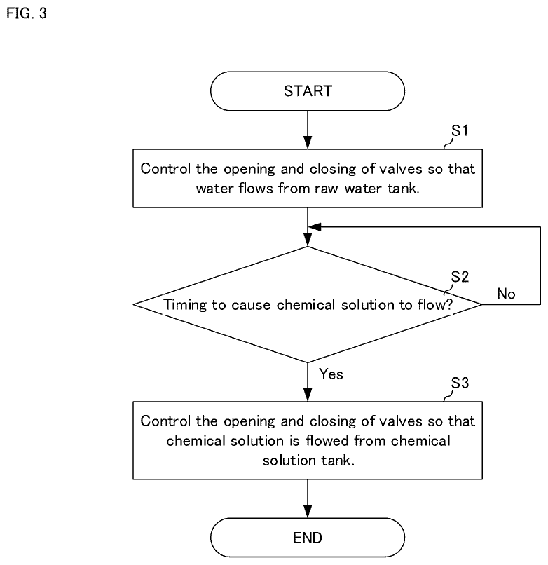

The operation method in the water treatment system shown in FIG. 2 is next described. FIG. 3 is a flowchart illustrating a first example of the operation method in the water treatment system shown in FIG. 2.

First, to perform the water flow process, controller 600 controls the opening and closing of valves 510, 520, 530, and 540 so that water flows from raw water tank 100 (Step S1). Specifically, controller 600 controls the opening and closing of valve 510 so that liquid from raw water tank 100 is supplied to degasser 200. Controller 600 also controls the opening and closing of valves 520 and 530 so that the liquid from degasser 200 is supplied to water treatment device 300. Controller 600 also controls the opening and closing of valve 540 so that liquid from water treatment device 300 is supplied to the treated water tank.

After controller 600 controls the opening and closing of valves 510, 520, 530, and 540 so that the water from raw water tank 100 flows and the water flow process is performed, controller 600 next determines whether the time has arrived for chemical solution to flow based on a preset schedule (Step S2). The timing for the flow of the chemical solution is the timing of the transition from the water flow process to the chemical flow process.

Upon determining that the time has arrived for the chemical solution to begin flowing, controller 600 controls the opening and closing of valves 510, 520, 530, and 540 so that the chemical solution from chemical solution tank 400 is supplied in parallel to degasser 200 and water treatment device 300 (Step S3). Specifically, controller 600 controls the opening and closing of valve 510 so that liquid from raw water tank 100 is not supplied to degasser 200 and chemical solution from chemical solution tank 400 is supplied to degasser 200. Controller 600 also controls the opening and closing of valve 520 so that the chemical solution from degasser 200 flows into the path for disposal. Controller 600 also controls the opening and closing of valve 530 so that the chemical solution from chemical solution tank 400 is supplied to water treatment device 300. Controller 600 also controls the opening and closing of valve 540 so that the chemical solution from water treatment device 300 flows into the path for disposal.

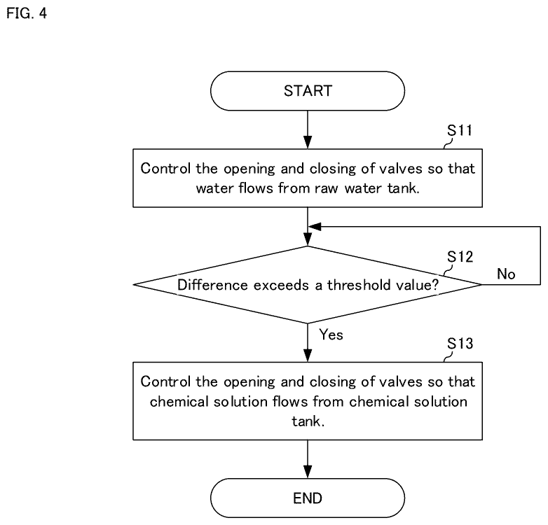

FIG. 4 is a flowchart illustrating a second example of the operation method in the water treatment system shown in FIG. 2.

First, to perform the water flow process, controller 600 controls the opening and closing of valves 510, 520, 530, and 540 so that water flows from raw water tank 100 (Step S11). Specifically, controller 600 controls the opening and closing of valve 510 so that liquid from raw water tank 100 is supplied to degasser 200. Controller 600 also controls the opening and closing of valves 520 and 530 so that the liquid from degasser 200 is supplied to water treatment device 300. Controller 600 also controls the opening and closing of valve 540 so that liquid from water treatment device 300 is supplied to the treated water tank.

After controller 600 controls the opening and closing of valves 510, 520, 530, and 540 so that the water from raw water tank 100 flows and the water flow process is performed, controller 600 next determines whether the difference between the pressure on the raw water side of degasser 200 and the pressure on the permeate side of degasser 200 (differential pressure) exceeds a predetermined threshold value (Step S12).

Upon having determined that the difference between the pressure on the raw water side of degasser 200 and the pressure on the permeate side of degasser 200 (differential pressure) exceeds a predetermined threshold value, controller 600 controls the opening and closing of valves 510, 520, 530, and 540 so that the chemical solution from chemical solution tank 400 is supplied in parallel to degasser 200 and water treatment device 300 (Step S13). Specifically, controller 600 controls the opening and closing of valve 510 so that liquid from raw water tank 100 is not supplied to degasser 200 and chemical solution from chemical solution tank 400 is supplied to degasser 200. Controller 600 also controls the opening and closing of valve 520 so that the chemical solution from degasser 200 flows into the path for disposal. Controller 600 also controls the opening and closing of valve 530 so that the chemical solution from chemical solution tank 400 is supplied to water treatment device 300 and further controls the opening and closing of valve 540 so that the chemical solution from water treatment device 300 flows into the path for disposal.

If the water treatment system has a redundant configuration with multiple operating series, when the series that is operating in the water flow process transitions from the water flow process to the chemical flow process, the other series will of course transition to the water flow process. This procedure is also true for the following embodiment.

As a result, in the process of causing chemicals to flow to regenerate the degasser and the water treatment device that make up the water treatment system in this embodiment, the chemical solution is supplied to the degasser and the water treatment device in parallel. Therefore, the system shutdown time associated with device regeneration can be easily reduced.

In the process of causing the chemical solution to flow, a valve can be provided at the position where chemical solution tank 400 shown in FIG. 2 branches off to valve 510 and valve 530, or the path from chemical solution tank 400 to valve 530 can be blocked/eliminated so that the chemical solution from chemical solution tank 400 is not directly supplied to valve 530. In this case, in the process of causing chemical solution to flow, the chemical solution from chemical solution tank 400 can be supplied to degasser 200 and the chemical solution that has passed through degasser 200 can be supplied to water treatment device 300. This configuration reduces both the amount of chemical solution used in the process of causing a chemical solution to flow and the amount of chemical effluent.

### Second Embodiment

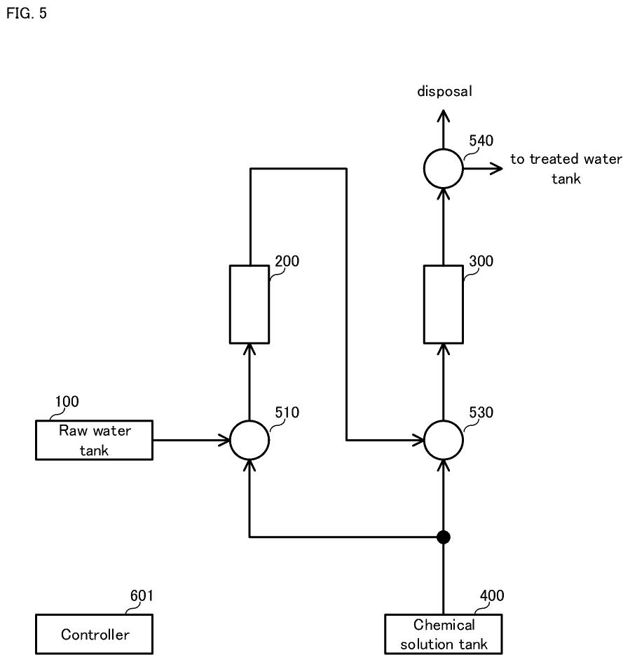

FIG. 5 is a diagram showing the second embodiment of the water treatment system of the present invention. As shown in FIG. 5, the water treatment system in this embodiment includes raw water tank 100, degasser 200, and water treatment device 300. These components are the same as those of the first embodiment. Furthermore, as shown in FIG. 5, the water treatment system in this embodiment also includes chemical solution tank 400, a plurality of valves 510, 530, and 540, which are on-off valves, and controller 601. The first group of valves consists of valve 510 and valve 530. This water treatment system may also be equipped with valve 520 of the first embodiment. The second group of valves consists of valve 520 and valve 530. Valve 530 belongs to both the first group of valves and the second group of valves. In other words, valve 530 plays a role in both the first group of valves and the second group of valves. If valve 520 is provided, controller 601 can control valve 520 to discharge the chemical solution that has passed through degasser 200 from the system immediately after the start of the chemical flow process. At a predetermined timing, controller 601 can then control valve 520 to supply the chemical solution that has passed through degasser 200 to valve 530. The predetermined timing may be, for example:
After the passage of a predetermined time;
When the value of TOC in the chemical solution from degasser 200 is less than a predetermined threshold value;
When the pH value of the chemical solution from degasser 200 becomes higher than a predetermined threshold value;
When the conductivity of the chemical solution from degasser 200 becomes higher than a predetermined threshold value.

The reason for this course of action is that in the early stages of the chemical flow process, the chemical solution that has passed through degasser 200 contains a large amount of removed contaminants that may again contaminate water treatment device 300. Another reason is to prevent chemical solution diluted with water contained in degasser 200 from flowing into water treatment device 300.

Valves 510, 530, and 540 and chemical solution tank 400 are each the same as the corresponding components in the first embodiment. In this embodiment, the distribution pipe from chemical solution tank 400 to degasser 200 and water treatment device 300 is the first distribution pipe. The distribution pipe from degasser 200 to water treatment device 300 via valve 530 is the second distribution pipe.

Controller 601 controls the opening and closing of valves 510, 530, and 540 provided in the pathways for the distribution of, for example, liquids to be treated, liquids that follow treatment, and chemical solutions. During the chemical flow process, controller 601 controls the opening and closing of valves 510 and 530 so that the chemical solution supplied from chemical solution tank 400 is supplied in parallel to degasser 200 and water treatment device 300. Specifically, controller 601 controls the opening and closing of valve 510 so that liquid from raw water tank 100 is not supplied to degasser 200 and chemical solution from chemical solution tank 400 is supplied to degasser 200. Controller 601 also controls the opening and closing of valve 530 so that the chemical solution from degasser 200 and the chemical solution from chemical solution tank 400 are supplied to water treatment device 300. In addition, controller 601 controls the opening and closing of valve 540 so that the liquid flowing from water treatment device 300 flows into the path for disposal. When valve 520 of the first embodiment is provided In this embodiment, controller 601 controls the opening and closing of valve 520 so that the chemical solution flowing out of degasser 200 is supplied to water treatment device 300 (valve 530). At this time, controller 601 may control the opening and closing of valves 520 and 530 to continue supplying chemical solution from chemical solution tank 400 directly to water treatment device 300 through valve 530. If the amount of chemical solution supplied to water treatment device 300 through degasser 200 is sufficient, controller 601 may control the opening and closing of valves 520 and 530 to shut off the supply of chemical solution from chemical solution tank 400 directly to water treatment device 300 through valve 530.

The timing of the transition from the water flow process to the chemical flow process is the same as the timing in the first embodiment.

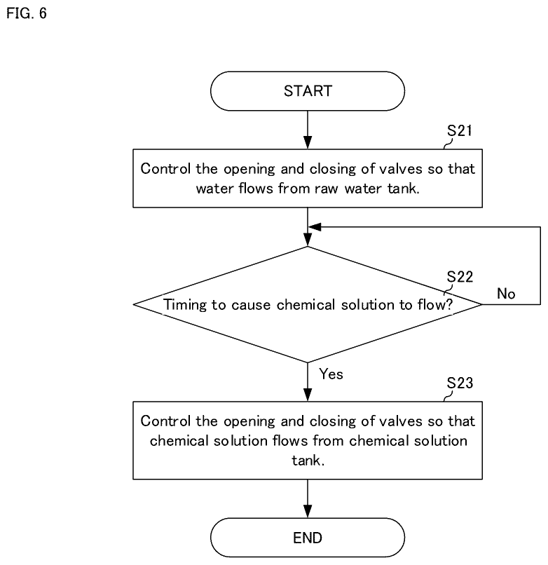

The operation method in the water treatment system shown in FIG. 5 is next described. FIG. 6 is a flowchart illustrating an example of the operation method in the water treatment system shown in FIG. 5.

First, to perform the water flow process, controller 601 controls the opening and closing of valves 510, 530, and 540 so that water flows from raw water tank 100 (Step S21). Specifically, controller 601 controls the opening and closing of valve 510 so that liquid from raw water tank 100 is supplied to degasser 200. Controller 601 also controls the opening and closing of valve 530 so that liquid from degasser 200 is supplied to water treatment device 300. Controller 601 also controls the opening and closing of valve 540 so that the liquid from water treatment device 300 is supplied to the treated water tank or other equipment installed downstream from the treated water tank.

After controller 601 has controlled the opening and closing of valves 510, 530, and 540 so that the water from raw water tank 100 flows and the water flow process is performed, controller 601 next determines whether the time to start the flow of chemical solution has arrived based on a preset schedule (Step S22). The timing to start the flow of chemical solution is the timing of the transition from the water flow process to the chemical flow process.

Upon determining that the time to start the flow of the chemical solution has arrived, controller 601 controls the opening and closing of valves 510, 530, and 540 so that the chemical solution is supplied from chemical solution tank 400 in parallel to degasser 200 and water treatment device 300 (Step S23). Specifically, controller 601 controls the opening and closing of valve 510 so that liquid from raw water tank 100 is not supplied to degasser 200 and chemical solution from chemical solution tank 400 is supplied to degasser 200. Controller 601 also controls the opening and closing of valve 530 so that the chemical solution from degasser 200 and the chemical solution from chemical solution tank 400 are supplied to water treatment device 300. Controller 601 also controls the opening and closing of valve 540 so that the chemical solution from water treatment device 300 flows into the path for disposal. When valve 520 of the first embodiment is provided in this embodiment, controller 601 controls the opening and closing of valve 520 so that the chemical solution flowing out of degasser 200 is also supplied to water treatment device 300 (valve 530).

Thus, in the process of causing chemicals to flow to regenerate the degasser and the water treatment device that make up the water treatment system in this embodiment, the chemical solution is supplied to the degasser and the water treatment device in parallel, thereby enabling an easy reduction of the system shutdown time associated with device regeneration. Furthermore, the chemical solution that has passed through the degasser is supplied to the water treatment device. This reduces the amount of chemical solution used in the chemical flow process and the amount of chemical effluent. If the chemical solution that has passed through the degasser is supplied to the water treatment device, the amount of chemical solution supplied from the chemical solution tank to the water treatment device can also be reduced.

### Third Embodiment

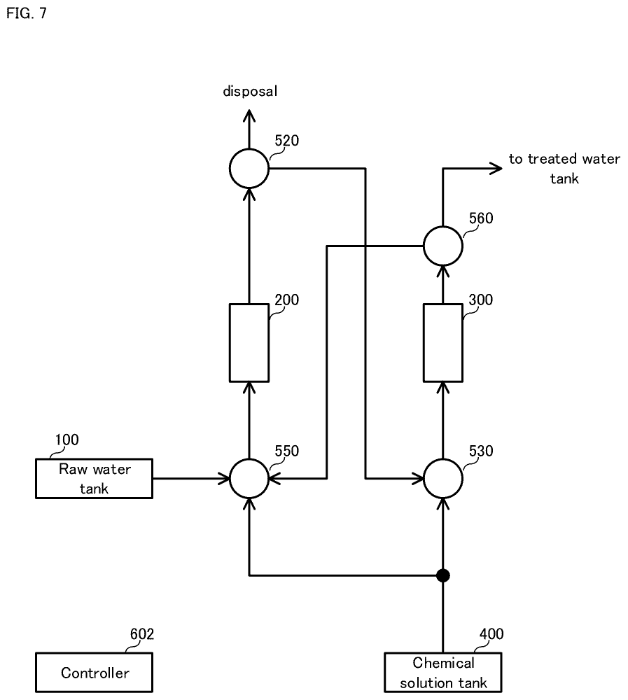

FIG. 7 is a diagram showing the third embodiment of the water treatment system of the present invention. As shown in FIG. 7, the water treatment system in this embodiment includes raw water tank 100, degasser 200, and water treatment device 300. These components are the same as those in the first embodiment. Furthermore, as shown in FIG. 7, the water treatment system in this embodiment includes chemical solution tank 400, a plurality of valves 520, 530, 550, and 560, which are on-off valves, and controller 602. The first group of valves consists of valve 530 and valve 550. The third group of valves consists of valve 550 and valve 560. Valve 550 belongs to both the first group of valves and the third group of valves. In other words, valve 550 plays a role in both the first group of valves and the third group of valves. Immediately after the start of the chemical flow process, the chemical solution that has passed through water treatment device 300 can be discharged from the system by controller 602 controlling valve 560. Then, at a predetermined timing, controller 602 controls valve 560 to supply the chemical solution that has passed through water treatment device 300 to valve 550. Examples of the predetermined timing include:
After the passage of a predetermined time;
When the value of TOC in the chemical solution from water treatment device 300 is less than a predetermined threshold value;
When the pH value of the chemical solution from water treatment device 300 exceeds a predetermined threshold value;
When the conductivity of the chemical solution from water treatment device 300 exceeds a predetermined threshold value

The reason for this course of action is that in the early stages of the chemical flow process, the chemical solution that has passed through water treatment device 300 contains a large amount of removed contaminants that may again contaminate degasser 200. Another reason is to prevent chemical solution diluted with water contained in degasser 200 from flowing into water treatment device 300.

Valves 520 and 530 and chemical solution tank 400 are each the same as the corresponding components in the first embodiment. In this embodiment, the distribution pipe from chemical solution tank 400 to degasser 200 and water treatment device 300 is the first distribution pipe. The distribution pipe from degasser 200 to water treatment device 300 via valves 520 and 530 is the second distribution pipe. The distribution pipe from water treatment device 300 to degasser 200 through valves 560 and 550 is the third distribution pipe.

Controller 602 controls the opening and closing of valves 520, 530, 550, and 560 provided in the pathways of the distribution of, for example, liquids to be treated, liquids following treatment, and chemical solutions. During the chemical flow process, controller 602 controls the opening and closing of the valves 520, 530, 550, and 560 so that the chemical supplied from chemical solution tank 400 is supplied in parallel to degasser 200 and water treatment device 300. Specifically, controller 602 controls the opening and closing of valve 550 so that liquid from raw water tank 100 is not supplied to degasser 200 and the chemical solution from chemical solution tank 400 is supplied to degasser 200. At this time, controller 602 controls valve 550 so that the chemical solution from water treatment device 300 through valve 560 is also supplied to degasser 200. Controller 602 also controls the opening and closing of valve 530 so that the chemical solution from chemical solution tank 400 is supplied to water treatment device 300. In addition, controller 602 controls the opening and closing of valve 560 so that the chemical solution flowing out of water treatment device 300 is supplied to valve 550. Controller 602 also controls the opening and closing of valve 520 so that the liquid flowing out of degasser 200 flows into the path for disposal. At this time, controller 602 may control the opening and closing of valves 550 and 560 to continue supplying chemical solution from chemical solution tank 400 directly to degasser 200 through valve 550. If the amount of chemical solution supplied to degasser 200 through water treatment device 300 is sufficient, controller 602 may control the opening and closing of valves 550 and 560 to shut off the supply of chemical solution from chemical solution tank 400 directly to degasser 200 through valve 550.

The timing of the transition from the water flow process to the chemical flow process is the same as the timing in the first embodiment.

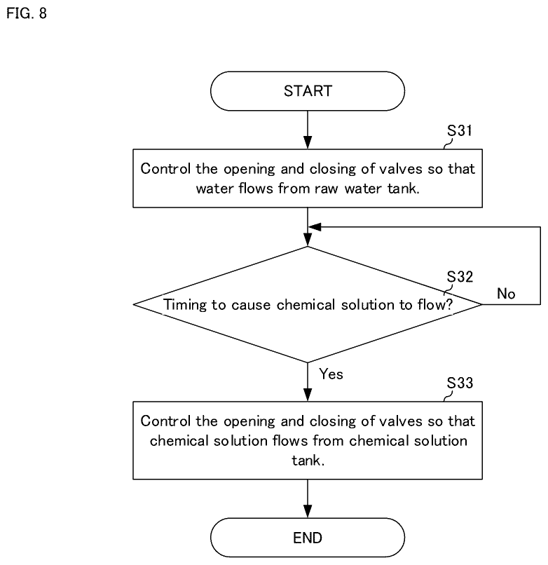

The operation method in the water treatment system shown in FIG. 7 is next described. FIG. 8 is a flowchart illustrating an example of the operation method in the water treatment system shown in FIG. 7.

First, to perform the water flow process, controller 602 controls the opening and closing of valves 520, 530, 550, and 560 so that water flows from raw water tank 100 (Step S31). Specifically, controller 602 controls the opening and closing of valve 550 so that liquid from raw water tank 100 is supplied to degasser 200. Controller 602 also controls the opening and closing of valves 520 and 530 so that the liquid from degasser 200 is supplied to water treatment device 300. Controller 602 also controls the opening and closing of valve 560 so that liquid from water treatment device 300 is supplied to the treated water tank.

After controller 602 has controlled the opening and closing of valves 520, 530, 550, and 560 so that the water flows from raw water tank 100 and the water flow process is performed, controller 602 next determines whether the time has arrived to cause the chemical solution to flow based on a preset schedule (Step S32). The timing for causing the chemical solution to flow is the timing of the transition from the water flow process to the chemical flow process.

Upon determining that the time has arrived to cause the chemical solution to flow, controller 602 controls the opening and closing of valves 520, 530, 550, and 560 so that the chemical solution from chemical solution tank 400 is supplied in parallel to degasser 200 and water treatment device 300, and the chemical solution from water treatment device 300 is supplied to degasser 200 through valves 550 and 560 (Step S33). Valves 530, 550, and 560 are controlled to open and close (Step S33). Specifically, controller 602 controls the opening and closing of valve 530 so that the chemical solution from chemical solution tank 400 is supplied to water treatment device 300. Controller 602 also controls the opening and closing of valve 560 so that the chemical solution is supplied from water treatment device 300 to valve 550. Controller 602 also controls the opening and closing of valve 550 so that the liquid from raw water device 100 is not supplied to degasser 200 and the chemical solution from chemical solution tank 400 and water treatment device 300 are supplied to degasser 200 through valve 560. In addition, controller 602 controls the opening and closing of valve 520 so that the chemical solution from degasser 200 flows into the path for disposal.

Thus, in the process of causing chemicals to flow and regenerate the degasser and the water treatment device that make up the water treatment system in this embodiment, the chemical solution is supplied to the degasser and the water treatment device in parallel. Therefore, the system shutdown time associated with device regeneration can be easily reduced. Furthermore, the chemical solution that has passed through the water treatment system is supplied to the degasser, thereby reducing both the amount of chemical solution used in the chemical flow process and the amount of chemical effluent.

### Fourth Embodiment

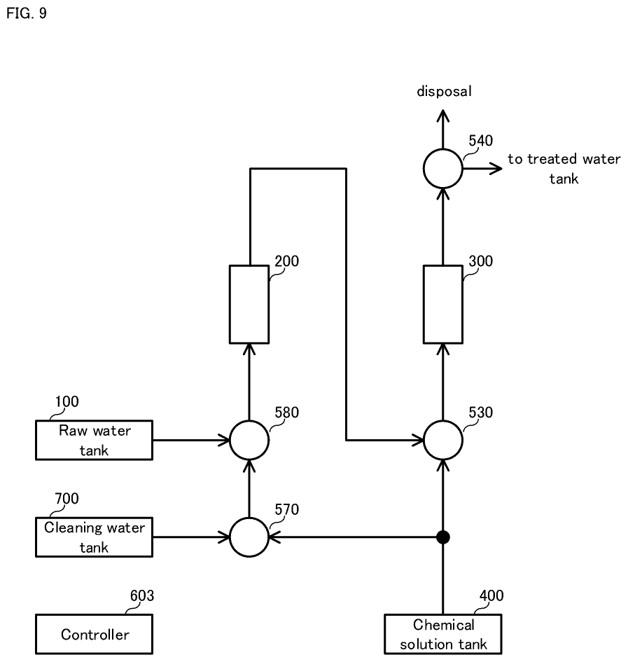

FIG. 9 is a diagram showing the fourth embodiment of the water treatment system of the present invention. In this embodiment, the operation of transitioning from the chemical flow process to the cleaning process is described. As shown in FIG. 9, the water treatment system in this embodiment includes raw water tank 100, degasser 200, and water treatment device 300. These components are the same as those in the first embodiment.

Furthermore, as shown in FIG. 9, the water treatment system in this embodiment includes chemical solution tank 400, a plurality of valves 530, 540, 570, and 580, which are on-off valves, controller 603, and cleaning water tank 700. In this embodiment, the fourth group of valves consists of valve 530, valve 570, and valve 580.

Valves 530 and 540 and chemical solution tank 400 are each the same as the corresponding components in the first embodiment. Chemical solution tank 400 is used in the chemical flow process that precedes the cleaning process and is not used in the cleaning process. Chemical solution tank 400 is shown in FIG. 9 because in this embodiment, the cleaning process performed after the chemical flow process is described as an example. In this embodiment, the distribution pipe from chemical solution tank 400 to degasser 200 and water treatment device 300 is the first distribution pipe. The distribution pipe from degasser 200 to water treatment device 300 via valve 530 is the second distribution pipe. The distribution pipe from cleaning water tank 700 to water treatment device 300 via degasser 200 is the fourth distribution pipe. The distribution pipe from valve 570 to degasser 200 via valve 580 serves as both the first and fourth distribution pipe. The distribution pipe from degasser 200 to water treatment device 300 via valve 530 serves as both the second and fourth distribution pipe.

Cleaning water tank 700 is a tank in which liquid (cleaning water) is stored for cleaning degasser 200 and water treatment device 300, the chemical solution being passed through these components in the cleaning process. Raw water, RO-treated water, ion-exchanged water, or pure water can be used as the cleaning water. If the cleaning water is raw water, the cleaning water tank can also serve as a raw water tank.

Controller 603 controls the opening and closing of valves 530, 540, 570, and 580 provided in the pathways of the distribution of, for example, liquids to be treated, liquids after treatment, chemical solutions, and cleaning water. Controller 602 controls the opening and closing of valves 530, 540, 570, and 580 so that, in the cleaning process that follows the chemical flow process, the cleaning water supplied from cleaning water tank 700 is supplied to degasser 200 and the cleaning water that has passed through degasser 200 is supplied to water treatment device 300. Specifically, when the chemical flow process is completed and the cleaning process is started, controller 603 controls the opening and closing of valve 570 so that the chemical solution from chemical solution tank 400 is not supplied to degasser 200 via valve 580 and so that the cleaning water from cleaning water tank 700 is supplied to degasser 200 via valve 580. Controller 603 also controls the opening and closing of valve 580 so that liquid from raw water tank 100 is not supplied to degasser 200 and cleaning water from valve 570 is supplied to degasser 200. Controller 603 also controls the opening and closing of valve 530 so that the chemical solution from chemical solution tank 400 is not supplied to water treatment device 300 and the cleaning water from degasser 200 is supplied to water treatment device 300. Controller 603 also controls the opening and closing of valve 540 so that the cleaning water from water treatment device 300 flows into the path for disposal.

The timing of the transition from the chemical flow process to the cleaning process can be set according to a predetermined schedule. The timing of the transition from the chemical flow process to the cleaning process can be at the time in the chemical flow process at which the amount of the chemical solution supplied from chemical solution tank 400 reaches a preset amount.

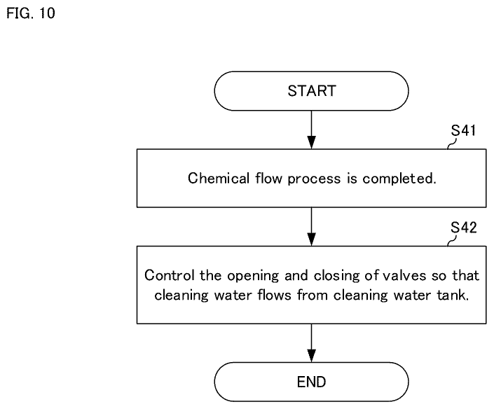

The operation method in the water treatment system shown in FIG. 9 is next described. FIG. 10 is a flowchart illustrating an example of the operation method in the water treatment system shown in FIG. 9.

When the chemical flow process is completed (Step S41), the opening and closing of valves 530, 540, 570, and 580 are controlled (Step S42) so that the cleaning water from cleaning water tank 700 is supplied to degasser 200 and the cleaning water that has passed through degasser 200 is supplied to water treatment device 300. Specifically, controller 603 controls the opening and closing of valve 570 so that the chemical solution from chemical solution tank 400 is not supplied to valve 580 and the cleaning water from cleaning water tank 700 is supplied to degasser 200 via valve 580. Controller 603 also controls the opening and closing of valve 580 so that liquid from raw water tank 100 is not supplied to degasser 200 and the cleaning water from valve 570 is supplied to degasser 200. Controller 603 also controls the opening and closing of valve 530 so that the chemical solution from chemical solution tank 400 is not supplied to water treatment device 300 and the cleaning water from degasser 200 is supplied to water treatment device 300. Controller 603 also controls the opening and closing of valve 540 so that the cleaning water from water treatment device 300 flows into the path for disposal.

Although the pathway of the chemical solution in the chemical flow process in this embodiment has been described using the same pathway as in the second embodiment, the pathway is not limited to this form. For example, the pathway used may be the same as that of the chemical solution in the first embodiment or the pathway for the chemical solution in the third embodiment.

Thus, in this embodiment, in the cleaning process that takes place after the process of causing chemicals to flow to regenerate the degasser and water treatment equipment that make up the water treatment system, cleaning water is supplied to the degasser, and the cleaning water that has passed through the degasser is supplied to the water treatment equipment. This process reduces both the amount of cleaning water used in the cleaning process and the amount of cleaning water discharged.

Water treatment device 300 may be arranged before degasser 200 in the water flow process. In the cleaning process of this configuration, the cleaning water used to clean water treatment device 300 and discharged from water treatment device 300 may be supplied to degasser 200, and the supplied cleaning water may then be used to clean degasser 200. Separate processes independent of each other may be performed for degasser 200 and water treatment device 300 before and after the water flow, chemical flow, and cleaning processes. For example, raw water may be used to perform processes such as a flushing process to replace the liquid in such devices as the degasser or water treatment device, a process of circulating a chemical solution through the degasser or separation membrane, an extrusion process of supplying water to the ion exchange resin to extrude the chemical solution, a circulation standby process of circulating water in the device in preparation for water sampling, and a soaking process. Regardless of which process is used, the present invention contributes to reducing the overall system downtime as well as to reducing the amount of chemicals and the amount of water used in the chemical/watering processes. In degasser 200 and water treatment device 300, no particular limitation applies to the direction of passage of raw water or the direction of passage of a chemical solution. For example, in FIG. 2, the direction in which raw water passes through degasser 200 and water treatment device 300 and the direction in which the chemical solution passes through degasser 200 and water treatment device 300 are shown as from bottom to top in FIG. 2, but these directions can also be from top to bottom. The direction in which the raw water flows and the direction in which the chemical solution flows can also be opposite to each other. These directions may be set from the outside.

### Example 1

### Water Flow Process

The raw water, from which turbidity and chlorine was removed by pre-treatment, was treated by a degassing membrane and an anion exchange resin device in that order to obtain treated water. A separation membrane module manufactured by 3M was used as the degassing membrane. The water treatment device was an anion exchange device filled with the anion exchange resin AMBERJET 4200 (DuPont) and IRA 96RF (DuPont) in a 2:1 ratio.

### Chemical Flow Process

Sodium hydroxide was added to the treated water obtained in the water flow process to prepare a sodium hydroxide solution with a concentration of 1.5% as a cleaning solution. The cleaning solution was passed through each of the degassing membrane and anion exchange resin device for regeneration. After regeneration was performed for a prescribed time, raw water was passed through the anion exchange resin device to clean the anion exchange resin. The raw water was then passed through the degassing membrane to clean the degassing membrane. After the degassing membrane and anion exchange resin device had been cleaned, the process transitioned to the water flow process.

### Example 2

During the cleaning process, raw water was passed through the anion exchange resin, and the water that passed through the anion exchange resin was then used to clean the degassing membrane.

### Comparative Example

The degassing membrane and anion exchange resin were regenerated and cleaned separately.

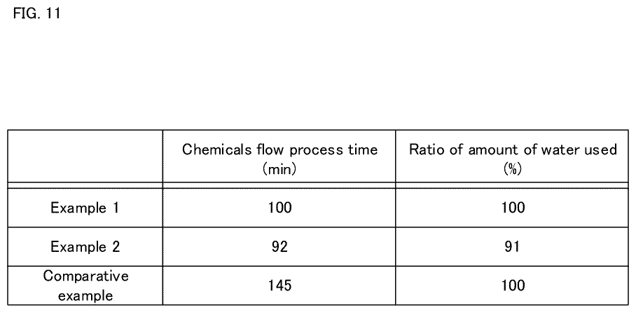

FIG. 11 is a table showing the results of Examples 1 and 2 and the comparative example. As shown in FIG. 11, the degassing membrane and anion exchange resin device were regenerated and cleaned separately in the comparative example. Therefore, the separate processing took a longer time. In Example 1, on the other hand, the degassing membrane and anion exchange resin were regenerated simultaneously. As a result, the chemical flow process time was reduced. In Example 2, the water used to clean the anion exchange resin was passed through the degassing membrane (was reused), and this process enabled a shortening of the cleaning time and a reduction of the amount of cleaning water used.

Although the invention has been described above by assigning each function (process) to a respective constituent element, these assignments are not limited to those described above. In addition, regarding the configuration of the constituent elements, the above-described embodiment is merely an example, and the present invention is not limited thereto. Further, the present invention may be a combination of the embodiments. Valves 510, 520, 530, 540, 550, 560, 570, and 580 described above are not limited to three-way valves, but can be a combination of mutually independent valves that open and close each input and output.

Although the invention has been described above with reference to embodiments, the invention is not limited to the above embodiments. Various changes can be made to the composition and details of the invention that will be understood by those skilled in the art within the scope of this application.

This application claims priority based on JP 2022-120285 filed on Jul. 28, 2022, all disclosures of which are incorporated herein.

1. A water treatment system equipped with a membrane separator and an ion exchange device, comprising:
a first distribution pipe that supplies chemical solution to the membrane separator and the ion exchange device in parallel at the same time;
a first group of valves that is installed in the first distribution pipe; and
a controller that controls the opening and closing of the first group of valves.

2. The water treatment system according to claim 1, wherein:
the controller controls the opening and closing of the first group of valves so that the chemical solution is supplied to the membrane separator and the ion exchange device when the difference between the pressure that precedes the membrane separator and the pressure that follows the membrane separator exceeds a predetermined threshold value.

3. The water treatment system according to claim 1, further comprising:
a second distribution pipe that supplies the chemical solution that has passed through the membrane separator to the ion exchange device; and
a second group of valves that is installed in the second distribution pipe, wherein
the controller controls the opening and closing of the second group of valves so that the chemical solution that has passed through the membrane separator is supplied to the ion exchange device.

4. The water treatment system according to claim 3, wherein:
the controller controls the opening and closing of the second group of valves based on at least one of a TOC value, a pH value, and conductivity of the chemical solution that has passed through the membrane separator so that the chemical solution that has passed through the membrane separator is supplied to the ion exchange device.

5. The water treatment system according to claim 1, further comprising:
a third distribution pipe that supplies the chemical solution that has passed through the ion exchange device to the membrane separator; and
a third group of valves that is installed in the third distribution pipe, wherein
the controller controls the opening and closing of the third group of valves so that the chemical solution that has passed through the ion exchange device is supplied to the membrane separator.

6. The water treatment system according to claim 1, wherein:
the ion exchange device is filled with an anion exchange resin, and
the chemical solution is an alkaline liquid.

7. The water treatment system according to claim 1, wherein:
the ion exchange device is filled with cation exchange resin, and
the chemical solution is an acidic liquid.

8. The water treatment system according to claim 1, further comprising:
a fourth distribution pipe that supplies cleaning water to the membrane separator and ion exchange device; and
a fourth group of valves that is installed in the fourth distribution pipe, wherein
the controller controls the opening and closing of the fourth group of valves so that the cleaning water is supplied to the membrane separator and the ion exchange device after the chemical solution has passed to the membrane separator and the ion exchange device.

9. A water treatment system equipped with a membrane separator and an ion exchange device, comprising:
a first distribution pipe that supplies chemical solution to the membrane separator;
a second distribution pipe that supplies the chemical solution that has passed through the membrane separator to the ion exchange device;
a first group of valves that is installed in the first distribution pipe;
a second group of valves that is installed in the second distribution pipe; and
a controller that controls the opening and closing of the first group of valves and the second group of valves, wherein
the controller controls the opening and closing of the second group of valves so that the chemical solution that has passed through the membrane separator is supplied to the ion exchange device.

10. A method for operating a water treatment system equipped with a membrane separator and an ion exchange device, the method comprising:
a water flow process for causing treated water to flow through the membrane separator and the ion exchange device by controlling the opening and closing of valves located in a distribution pipe; and
a chemical flow process for supplying chemical solution to the membrane separator and the ion exchange device in parallel simultaneously by controlling the opening and closing of the valves based on a predetermined timing.
